(19) United States
(12) Patent Application Publication
(10) Pub. No.: US 2021/0300792 A1
(43) Pub. Date: Sep. 30, 2021

(54) Water Sanitizing System

(71) Applicant: Cherie L. Brook, Huntsville, AL (US)

(72) Inventors: Ronald L. Barnes, Huntsville, AL (US); Cherie L. Brook, Huntsville, AL (US)

(21) Appl. No.: 17/230,964

(22) Filed: Apr. 14, 2021

Related U.S. Application Data
(63) Continuation-in-part of application No. 15/462,795, filed on Mar. 17, 2017, now abandoned.
Application No. 15/462,795 is a continuation-in-part of application No. 14/403,655, filed on Nov. 25, 2014, now abandoned.
(60) Provisional application No. 61/689,167, filed on May 30, 2012.

(51) Int. Cl. C02F 1/32; C02F 1/78; B01F 5/04

(52) U.S. Cl. CPC C02F 1/325; C02F 1/78; B01F 5/0423; B01F 2215/0052; C02F 2301/063; C02F 2201/32; C02F 2201/78; C02F 2301/04

(57) ABSTRACT

A sanitizer system has an ultraviolet (UV) lamp, a UV transparent tube and Venturis that that draw ozonated air from near the UV lamp and mix the ozonated air with water traveling through the UV transparent tube while UV light breaks down ozone in the UV transparent tube into free radicals and other ozone decomposition products. Additional ozone can be introduced into what after it passes through the UV transparent tube.

### CROSS REFERENCE TO RELATED APPLICATIONS

This application is a continuation-in-part of U.S. Ser. No. 15/462,795 filed Mar. 17, 2017, which is a continuation-in-part of U.S. Ser. No. 14/403,655 filed Nov. 25, 2014 and claims priority to U.S. 62/309,783 filed Mar. 17, 2016. U.S. Ser. No. 14/403,655 is a national stage entry of PCT/US2013/043485 filed May 30, 2013, which claims the benefit of provisional application U.S. 61/689,167 filed May 30, 2012.

### FIELD OF THE INVENTION

This application relates to a water sanitizer wherein a flow of water is sanitized using ultraviolet (UV) light as well as ozone and ozone decomposition products generated by UV light.

### BACKGROUND OF THE INVENTION

In a conventional UV light sanitizer, UV light is used to produce ozone, which in turn is provided to a flow of water in order to sanitize the water. A sanitizer system is disclosed that uses both ozone and UV light to effect sanitization of water flowing therethrough.

### BRIEF DESCRIPTION OF THE DRAWINGS

The elements of the drawings are not necessarily to scale relative to each other, with emphasis placed instead upon clearly illustrating the principles of the disclosure. Like reference numerals designate corresponding parts throughout the several views of the drawings in which:

FIG. 1 is a sectional view of a first embodiment of a sanitizing system;

FIG. 1A is an enlarged sectional view of a second embodiment of a sanitizing system;

FIG. 2 is a sectional view through a Venturi mixer of a sanitizing system;

FIG. 3 is a sectional view of a third embodiment of a sanitizing system;

FIG. 4 is a diagrammatic view of a first embodiment of an ozone-producing portion of a sanitizing system;

FIG. 5 is a diagrammatic view of a second embodiment of an ozone-producing portion of a sanitizing system;

FIG. 6 is a diagrammatic view of a hydroxyl producing portion of a sanitizing system; and

FIG. 7 is a diagrammatic illustrating one embodiment of an arrangement of ozone-carrying tubes of a sanitizing system.

### DETAILED DESCRIPTION OF THE INVENTION

Specific embodiments of the invention are described with reference to the drawings. The invention may be embodied in different forms and should not be construed as limited to the embodiments set forth herein. Instead, these embodiments are provided so that this disclosure will be thorough and convey the scope of the invention to those skilled in the art. All art specific terms used herein are intended to have their art-accepted meanings in the context of the description unless otherwise indicated. All non art specific terms are intended to have their plain language meaning in the context of the description unless otherwise indicated.

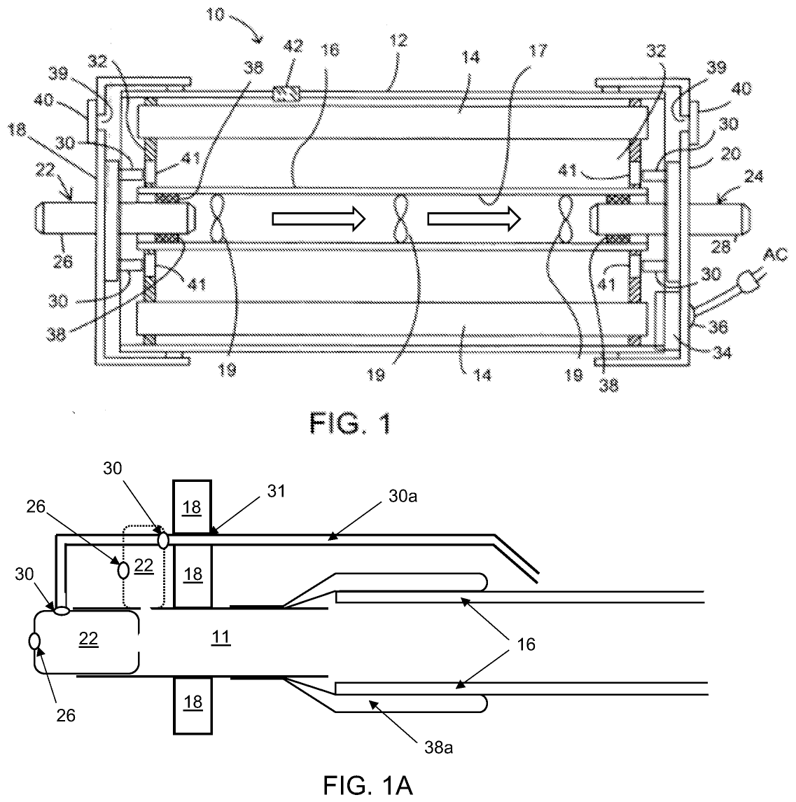

Referring to FIG. 1, a first embodiment of a water sanitizer 10 is shown in a horizontal orientation with a direction of water flow indicated by open arrows from left to right. This orientation is selected for ease of illustration and the water sanitizer need not be oriented horizontally but may be oriented at any angle with respect to the horizontal, such as vertically with water flowing upwardly or downwardly. The water sanitizer 10 in FIG. 1 comprises a housing 12 enclosing ozone generating components. The housing 12 may be constructed of a suitable material such as steel or aluminum that dissipates and radiate heat and may be provided with heat-radiating fins. One or more inner surfaces of the housing 12 may be reflective surfaces made of polished steel or aluminum to reflect UV light and/or the housing 12 may contain one or more UV light reflectors having reflective surfaces. The UV light reflecting surfaces, if present, may be parabolic, hyperparabolic, semicircular, or rectangular or in a cross-sectional shape and are preferably configured to focus light from one or more UV lamps 14 into a UV transparent tube 16 configured to receive a flow of water to be sanitized. In an alternative embodiment, the housing may be omitted entirely with a reflector being provided to reflect or direct UV light to the tube 16. The reflector is preferably of a material such as anodized aluminum that reflects at least the 254 nm wavelength of UV light.

FIG. 1 shows an embodiment of a sanitizer 10 comprising two UV lamps 14 disposed around a UV transparent tube 16. The number of lamps 14 may be increased or decreased. When the sanitizer 10 is in use, water flowing through UV transparent tube 16 is sterilized or sanitized by a combination of UV light and ozone. The UV lamps 14 predominantly produce 185 nm and 254 nm UV light wavelengths. The 185 wavelength UV light generates ozone from oxygen in the air. The 254 nm wavelength of UV light decomposes ozone to form free radicals and other ozone decomposition products, which are very reactive species with potent sterilizing effect and very short half-lives.

Since the 185 nm wavelength is absorbed after only a short distance through the atmosphere, the UV lamps 14 are preferably positioned from about 0.25 inches to about 2 inches, or about 0.5 cm to about 5 cm from the UV transparent tube 16. The UV transparent tube 16 may be made of pure or ultrapure quartz that is transparent to both the 185 nm and 254 nm wavelengths of UV light. The UV lamp(s) 14 may be mercury plasma lamps wrapped with a wire through which a pulsed voltage, such as a square wave or a spike from a flyback transformer is passed, in order to develop a theta pinch on the mercury plasma and to energize the air in the immediate vicinity of the lamp. The theta pinch drives electrons in the mercury plasma away from the inner surface of the quartz walls. This causes the UV lamps 14 to operate at cooler temperatures and extends the life of the UV lamps by reducing collisions of the electrons with the quartz walls.

The interior of a quartz UV transparent tube 16 may be coated with a non-stick surface 17, such as one or more UV transparent Teflons™ such as FEP and TFE to prevent debris and oils from sticking to the interior walls. The UV transparent tube 16 may be alternatively fabricated of TFE or FEP. Static mixers 19 may be fixed in UV transparent tube 16 in order to create turbulence in the water flowing through UV transparent tube 16 to increase uniform exposure of the water to UV germicidal radiation from UV lamp(s) 14. End panels 18, 20 may be present to enclose ends of the sanitizer 10 within the housing 12 and/or to directly or indirectly support the UV transparent tube 16. In FIG. 1, end panels 18, 20 support UV transparent tube 16 via Venturis 22 and 24, respectively. Additionally or alternatively, the UV transparent tube 16 may be supported by the end enclosures 18,20, optionally with cushioning seals between the end enclosures and the UV transparent tube 16.

FIG. 1A is an enlarged view illustrating alternative configurations for the UV transparent tube 16 relative to the end panel 18. The UV transparent tube 16 is connected to a water inlet pipe 11 by a double walled silicone fitting 38a that may be tapered to a smaller diameter of the inlet pipe 11 relative to the diameter of the UV transparent tube 16. The double walled silicone fitting 38a comprises a silicone filled sleave configured to receive and hold the UV transparent tube 16. The end of the silicone seal configured to receive and hold the water inlet pipe 11 need not but may also comprise a double walled, silicone filled sleave. A cushion or o ring (not shown) of flexible material may be present to prevent the ends of the UV transparent tube 16 and water inlet pipe 11 from touching. The double walled silicone fitting 38a may be replaced by other fittings 38 such as hose barb or slip fittings that comprise, or have added, surfaces that do not damage the UV transparent tube 16.

Water inlet pipe 11 passes through end panel 18, which supports water inlet pipe 11 which, through silicone seal 38a supports UV transparent tube 16. An upstream Venturi 22 may be positioned upstream in line with water inlet pipe 11 either in or on the inlet pipe 11 or on or in a hose or tube connected to the inlet pipe 11. Additionally or alternatively, a Venturi 22 (dashed lines) may be positioned in apposition to and fluidically connected with the water inlet pipe 11. The Venturi 22 receives ozonated air via an ozone delivery tube 30a passing through opening 31 and delivers ozone into water passing through water inlet pipe 11. Venturi 22 comprises a water inlet port 26 for receiving a flow of water to be mixed with ozone and delivered into water inlet pipe 11. Venturi 22 comprises one or more suction ports 30 for receiving ozonated air configured to draw ozonated air via ozone delivery tube 30a to be mixed with delivered into, and mixed with, water in inlet pipe 11.

At the opposite end of the UV transparent tube 16, downstream Venturi 24 is similarly connected to the UV transparent tube 16 by a silicone seal 38a to a water outlet pipe that passes through end panel 20, which supports the water outlet pipe which, through silicone seal 38a supports the opposite end of UV transparent tube 16. Downstream Venturi 24 may be configured similarly to upstream Venturi 22 with suction port(s) 30 for receiving ozonated air configured to draw ozonated air via ozone delivery tube 30a to be mixed with delivered into, and mixed with, water in the water outlet pipe. Downstream Venturi 24 comprises a water inlet port 26 for receiving a flow of water from the water outlet pipe to be mixed with ozone and delivered downstream into water outlet pipe 11. Additionally or alternatively, the downstream Venturi 24 may be positioned downstream of and in fluid communication with the water outlet pipe.

In a preferred embodiment, Venturis 22 and/or 24 are be of the type disclosed in U.S. Pat. No. 6,192,911, issued Feb. 27, 2001, which is incorporated herein by reference in its entirety. Such a Venturi is provided with an annular cavity around the motive flow through the Venturi, the cavity communicating with multiple suction ports 30 used to draw fluids and/or gasses into the motive flow. Venturis 22 and 24 are each provided with a water inlet port 26 and a water outlet port 28 with water flow through upstream Venturi 22, the UV transparent tube 16, and downstream Venturi. Water flow is shown as left to right as in FIGS. 1 and 1A but the system may be reconfigured or reoriented for vertical, upward or downward flow or inclined or declined flow at any angle.

Suction ports 30 of at least the upstream Venturi 24 (FIG. 1) are oriented near the UV lamp 14 so as to draw air containing ozone generated by the UV lamp(s) 14 directly from the interior of housing 12 into the flow of water through UV transparent tube 16. This eliminates tubing that would otherwise be necessary to connect an ozone generator to the Venturi 24 and increases the amount of ozone available for sanitization due to greatly reducing the distance the ozone must travel before being put into the water, which in turn reduces the amount of ozone that breaks down before reaching the water entering UV transparent tube 16. The embodiment shown in FIG. 1A comprises an upstream Venturi 22 positioned outside the housing 12 with suction port(s) 30 receiving ozonated air via ozone delivery tube 30a. This configuration provides the advantage of easy connection to existing water lines, for example via saddle valves, without risk of damage to the UV transparent tube 16. Similarly, a downstream Venturi 24 positioned outside the housing 12 with suction port(s) 30 receiving ozonated air via an ozone delivery tube 30a provides the same advantages.

Variations of the water sanitizing system may include varying the sizes of inlet openings of the suction ports 30 on the upstream Venturi 22 and downstream Venturi 24 to provide more air flow and therefore more ozone to either the water flow through the UV transparent tube 16 or downstream of the UV transparent tube 16. The downstream Venturi 24 may comprise one or more suction ports configured and oriented on the outside of housing 12 for connection to one or more sources of fluids such as buffering solutions or biguanide, peroxide, algicides, or other chemical sanitizing solutions or fluids. Embodiments comprising this feature may be particularly useful for applications to pool water sanitization. The upstream Venturi 22 may be similarly configured.

The design of sanitizer 10 ensures that ozone generated from oxygen in the air around the UV lamp(s) 14 by the 185 nm wavelength UV light is injected into the water flowing into UV transparent tube 16 and that the aqueous ozone in the tube 16 is exposed to intense 254 nm wavelength UV to generate free radicals and other highly reactive ozone decomposition products. When used in a spa, hot tub or the like, the contact distance for dissolving ozone may be short, so static mixers 19 may be provided in UV transparent tube 16 to create turbulence that disrupts laminar flow and provides better ozone mixing in the water to promote the formation of advanced oxidation species and other reactions.

Other components may include supports 32 at each end or side of the sanitizer 10, which support the UV lamp(s) 14, and water tube 16 via Venturis 22, 24. A ballast 34 for connection to electrical power may be mounted on one of supports 32. Other ballasts 34 may be mounted as needed on the outside of the sanitizer 10, or nearby in one or more separate enclosures. A silicone or other suitable fitting 38 may be used at each end of UV transparent tube 16 to form a seal between the water tube and the respective Venturi outlet/inlet 26, 28. One or more air inlets 39, for example in one or more end panels 18, 20 and/or housing 12, configured to allow air to be drawn through the housing maybe provided. Air inlets 39 may be equipped with air filters 40. Where supports 32 are disk-like, solid supports, openings 41 may be provided to allow free passage of air from near the UV lamps 14 to the Venturi suction ports 30. A window 42 may be provided for optically coupling radiation from lamp(s) 14 to sensing or monitoring circuitry, or for observation to determine that the lamp(s) are working.

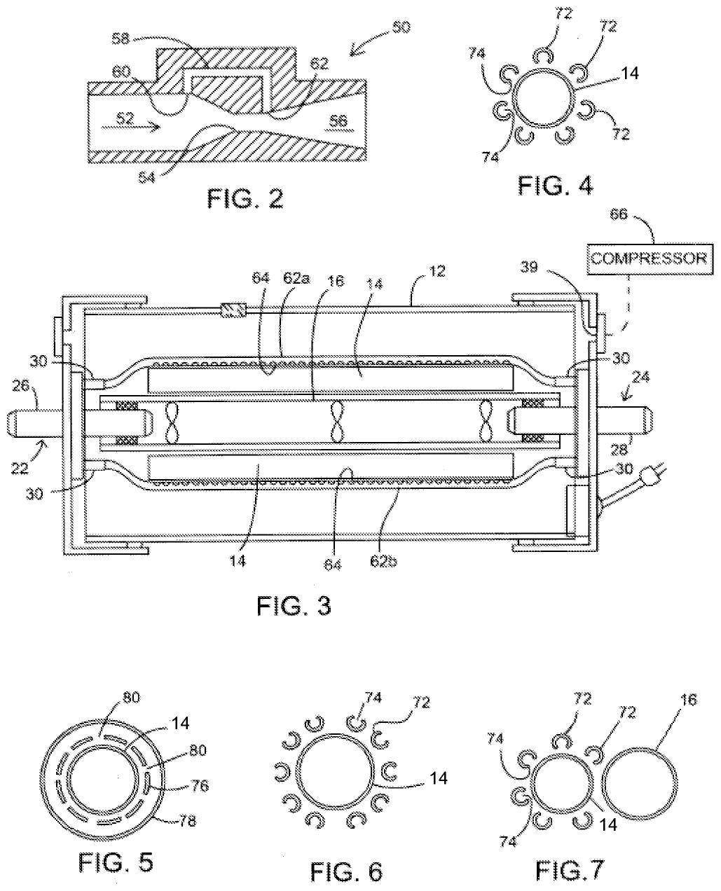

FIG. 2 is a cross sectional view of a venturi-like mixer 50 that may be placed between upstream Venturi 22 to further mix ozone and water flowing through UV transparent tube 16. Additionally or alternatively, a venturi-like mixer 50 may be positioned downstream of the downstream Venturi 24 to further mix ozone and water downstream of the UV transparent tube 16. Water flows through a typical Venturi inlet 52, a constriction 54 and an outlet 56 that is typically several times longer than the inlet. Rather than having a suction port, a bypass tube or passage 58 is provided and extends between a point 60 where the inlet just begins to narrow to a point 62 where the greatest suction from the Venturi occurs. A venturi-like mixer 50 may substituted for the downstream Venturi 24 in FIG. 1, with an outlet of venturi-like mixer 50 supporting one end of the UV transparent tube 16. A portion of the mixture of ozone-containing air and water provided by upstream Venturi 22 that flows through tube 16 and venturi-like mixer 50 is drawn through bypass 58 and reinjected into the stream of water and ozone-containing air, which creates considerably more turbulence than a second Venturi. In use, a froth of air, ozone, and water may be passed from venturi-like mixer 50, which considerably reduces a required contact distance for ozone to dissolve into the water.

FIG. 3 shows an embodiment of a sanitizer 10 in which Venturi suction ports 30 are each connected to tubing 62, each of the sections of tubing 62a, 62b connected as shown at each end between respective upper and lower pairs of Venturi suction ports 30. Sections of tubing 62a, 62b are positioned to run as shown substantially the entire length of UV lamps 14, and very close to or even touching tubes 14, with possible spacings being within ⅛ inch to ½ inch or so to the surface of tubes 14. In larger designs using larger UV lamps, this distance may be extended up to about 1-3 inches, depending on the intensity of UV light emitted from the UV lamp(s) 14. A multitude of small holes or openings 64 in tubes 62a and 62b extend the length of UV tubes/lamps 14, and may be spaced anywhere from up to about ⅛th inch to 1 inch apart, depending on airflow through tubes 62a and 62b. In other embodiments, a single slit in an air tube 62a, 62b may run the length of a respective UV lamp. With this construction, the Venturi suction developed by Venturis 22, 24 is felt inside tubes 62a and 62b, causing air to be drawn into tubes 62a and 62b via the plurality of openings 64 in each of tubes 62a and 62b. The tubes 62a and 62b are also applicable to the embodiment shown in FIG. 1A for connection to ozone delivery tube(s) 30a that are configured to provide ozone to Venturis 22 and 24.

Embodiments of the sanitizer system 10 may comprise a compressor 66 configured to force air through opening 39 to pressurize air and/or increase airflow through the interior of housing 12 to suction ports 30, optionally through into openings 64 if tubes 62a and 62b are present. Air drawn or forced into tubes 62a and 62b travels very close to the quartz surface of UV lamps 14 and is thereby enriched in ozone over and above an ozone level obtained from an embodiment as shown in FIG. 1. This is because 185 nm wavelength UV light propagates through air at atmospheric pressure only a very short distance before being absorbed by oxygen molecules such that the intensity of the 185 nm wavelength is reduced by about half at a distance of about ½ inch from the surface of tubes 14. In contrast, 254 nm wavelength UV light propagates a greater distance through air and, in an ozone generator environment, is only degraded when absorbed by ozone molecules to generate diatomic oxygen, free oxygen, hydroxyl radicals, and other ozone decomposition products. When combined with proper pulsing of the UV tubes 14 with high current and a high voltage spike pulse train, very intense bursts of UV light in both the 185 nm and 254 nm wavelengths may be produced. Short bursts of very intense UV light allows the 185 nm wavelength to create a relatively large quantities of ozone at the surface of the UV tube 14 and the pulse terminates before the ozone is destroyed by the 254 nm wavelength. Referring to FIG. 3, tubes 62a and 62b are about 15 centimeters long and openings 64 are each about 0.06 inches in diameter and spaced about 0.25 inches apart along the length of tubes 62a and 62b. Airflow through tubes 62a and 62b is essentially unrestricted. For tubes 62a and 62b having an internal volume of 18 cubic centimeters and airflow through each tube of 3 liters per minute, with the tubes 62a and 62b spaced about a centimeter from the UV tube 14, it takes about 0.277 seconds to evacuate the air and ozone between each of tubes 62a, 62b and the UV tube 14. In this example, the plasma tubes may be pulsed about 3 times a second to create an optimum amount of ozone. If the tubes 62a and 62b are 0.5 centimeters from UV tube/lamp 14, then the UV tubes 14 may be pulsed about 6 times a second to create am optimum amount of ozone. In this example, the pulses may be high powered pulses of a duration of 5 milliseconds to 20 milliseconds. The shorter the pulse duration, the higher peak power may be applied to the UV tube 14. A peak or instantaneous power of up to 1000 watts per pulse may be used. This process creates ozone molecules between the surface of UV lamp 14 and the nearest opening 64 and allows the newly-created ozone molecules to be drawn into a nearest opening 64 without being destroyed before the next burst of UV light is generated. Such a process generates significantly more ozone than a conventional ozone generator. The desired frequency of pulses for any given rate of air flow into openings 64 can be determined by calculation, or empirically simply by measuring a quantity of ozone in a given air flow rate from the ozone generator at a given frequency of the high current, high voltage pulse train, and adjusting the frequency of the pulse train until the frequency at which a highest level of ozone is produced is determined. Alternately, the frequency of the pulse train may be set, and the air flow rate adjusted until a highest level of ozone generation is measured. Water flowing through water UV transparent tube 16 may be slowed to a rate that allows at least one or two high power pulses to be applied to water passing therethrough.

FIG. 4 is a cross-section view of a UV tube 14 surrounded by a plurality of tubes 72, each have a plurality of openings or a narrow slot 74 extending lengthwise along the length of tubes 72. Tubes 72 may be constructed of aluminum, stainless steel, or an UV-resistive plastic such as a Teflon™-type material. Tubes 72 are located very close to UV tube 14 to draw ozone from the region between openings or slots 74 and the surface of the UV tube 14. A source of suction (not shown) may be connected to one or both ends of tubes 72, or to intermediate locations between the ends of tubes 72. FIG. 7 shows a UV transparent tube 16 in close proximity to UV lamp 14.

FIG. 5 is a cross section view showing a UV tube 14 surrounded by an inner tube 76 and an outer tube 78. Tube 76 has a plurality of slots or openings 80 through which air is drawn, with the solid outer tube 78 closed at one end with the other end connected to a source of suction. Tube 76 is open to a source of air or oxygen, such as at one or both ends, or from middle regions of tube 76, so that air or oxygen is drawn into openings 80 from the closely spaced region between UV tube 14 and inner tube 76. In other embodiments, and as described with respect to FIG. 4, the embodiment of FIG. 5 may be mounted in a housing as shown in FIG. 1, and a compressor used to pressurize the interior of tube 76 in order to drive air and ozone from between the region between the surface of UV tube 14 and tube 76 into openings or slots 80, where the air and ozone is captured by outer tube 78. Air and ozone may be drawn off at the ends of the tubular structures, such as tubes 72 and 78, or from intermediate locations between the ends of the tubes 72 and 78, or both. As such, for larger ozone generators, ozone may be drawn off from both ends of tubes 72, 78 and from several ports between the ends of tubes 72, 78. This prevents ozone moving in the tubes past openings or slots 74, 80 from being exposed to additional UV light shining through the openings or slots 74, 80. The interiors of tubes 72, 76, 80 may be darkened to absorb UV light so that 254 nm wavelength UV light is not reflected within these tubes. A multitude of tubes 72 may be closely spaced together or touching around UV tube 14. This eliminates the need for reflectors around UV tube(s) 14 and blocks UV light from reaching UV transparent tube 16. However, the embodiments shown in FIGS. 4 and 5 may form the basis for an efficient ozone generator for providing a mixture of air and ozone to be mixed with water or for sanitizing air.

FIG. 7 is a cross-sectional view of a sanitizer in which some of tubes 72 are connected to Venturis that support a UV transparent tube 16 as described above for providing ozonated air to a flow of water. Other tubes 72 are connected for another purpose, such as sanitizing air or water for commercial ice makers. For ice maker applications, ozonated air from some of tubes 72 connected as described to Venturi suction ports may be provided to water flowing through UV transparent tube 16 for sanitizing water from which ice is made. Where the ice is stored in a refrigerated compartment prior to use, air in the ice-storing compartment may also be ozonated by connecting others of tubes 72 to an air compressor for drawing ozonated air into the interior of the ice-storing compartment, sterilizing the air within the compartment. For such an application, a housing 12 for the sanitizer 10 may be airtight with compressed air being provided to the interior of the compartment to force air into tubes 72 via openings 74. Those tubes 72 not connected to a Venturi suction port are connected to the interior of the ice compartment. Such a construction augments suction from the Venturi suction ports that provide ozonated air to the water flowing through UV transparent tube 16.

For applications in which it is desired that less ozone and more hydroxyl radicals are to be produced, and referring to FIG. 6, a UV tube 14 may be surrounded by a plurality of tubes 72 as shown in FIG. 4, except that the openings or slots 74 are oriented away from the surface of UV lamp 14. In this arrangement, more of the ozone molecules created at the surface of UV tube/lamp 14 are destroyed by the 254 nm wavelength of the UV light, which creates more free hydroxyl radicals that also can be used for sanitization or other purposes. If desired, humidified air may be provided to the region around UV tube 14 in order to increase the quantity of hydroxyl radicals and other ozone decomposition products produced.

1. A sanitizer system comprising:
an ultraviolet-transparent, water carrying tube;
an ultraviolet lamp positioned adjacent to said ultraviolet-transparent, water carrying tube;
a first Venturi upstream of said water carrying tube, said first Venturi configured to receive ozonated air from a region around said ultraviolet lamp and mix said ozonated air with a flow of water entering the ultraviolet-transparent, water carrying tube; and
a second Venturi downstream of said ultraviolet-transparent, water carrying tube, said second Venturi configured to receive ozonated air from a region around said ultraviolet lamp and mix said ozonated air with a flow of water downstream of said ultraviolet-transparent, water carrying tube
wherein:
said first Venturi comprises a first suction port, a first water inlet port, and a first water outlet port;
said second Venturi comprises a second suction port, a second water inlet port, and a second water outlet port;
a first end of said ultraviolet-transparent water carrying tube is supported by said first water outlet port or an inlet pipe connecting said first water outlet port to said first end of said ultraviolet-transparent water carrying tube and
a second end of said ultraviolet-transparent water carrying tube is supported by said second water inlet port or an outlet pipe connecting said second water inlet port to said second end of said ultraviolet-transparent water carrying tube.

2. The sanitizer system of claim 1, further comprising a housing enclosing said ultraviolet lamp and said ultraviolet-transparent water carrying tube, with ends of said housing supporting said inlet pipe and said outlet pipe or supporting said first Venturi and said second Venturi.

3. The sanitizer system of claim 1, further comprising at least one additional suction port on at least one of said first Venturi and said second Venturi, and wherein said additional suction port extends outside of said housing and is configured for connection to a source of a fluid chemical composition and for injecting said fluid chemical composition into a flow of water through said at least one of said first Venturi and said second Venturi into a flow of water either upstream or downstream of said ultraviolet-transparent, water carrying tube.

4. The sanitizer system of claim 1, wherein said sanitizer system further comprises a reflecting surface configured for reflecting ultraviolet light into said ultraviolet-transparent, water carrying tube.

5. The sanitizer system of claim 1, further comprising an additional ultraviolet lamp positioned adjacent said water carrying tube.

6. The sanitizer system of claim 5, wherein said ultraviolet lamp and said additional ultraviolet lamp are operated by pulses of high power having a predetermined frequency and duration determined according to a rate of air flow through said tube.

7. The sanitizer system of claim 1, further comprising a tube connected to at least one of said first and second suction ports, and wherein:
said tube extends the length of said ultraviolet lamp in close proximity with said ultraviolet lamp and
said tube comprises one or more openings facing a surface of said one or more ultraviolet lamps for drawing said ozonated air directly from said region around said ultraviolet lamp and injecting said ozonated air into water flowing through said water carrying tube prior to exposing said water to ultraviolet light from said ultraviolet lamp.

8. The sanitizer system of claim 7, wherein said one or more openings extend along said air tube for the length of said ultraviolet lamp.

9. The sanitizer system of claim 7, wherein said tube extends along said ultraviolet lamp within about 0.625 cm to about 1.25 cm from a surface of said ultraviolet lamp.

10. The sanitizer system of claim 1, wherein said ultraviolet lamp is operated by pulses of high power having a predetermined frequency and duration.

11. The sanitizer system of claim 1, wherein one or both of the first Venturi and the second Venturi act as mixers for mixing said ozonated air with water.

12. The sanitizer system of claim 1, further comprising static mixing elements in the ultraviolet-transparent, water carrying tube.

13. The sanitizer system of claim 1, wherein the ultraviolet-transparent, water carrying tube is oriented vertically and said first end of said ultraviolet-transparent water carrying tube is below said second end of said ultraviolet-transparent water carrying tube.

14. A sanitizer system comprising:
an ultraviolet lamp;
an ultraviolet-transparent, water carrying tube positioned adjacent to said ultraviolet lamp;
a first Venturi having a first suction port, a first water inlet port, and a first water outlet port and
a mixer comprising a second water inlet port configured to receive ozonated water from a second end of said ultraviolet-transparent water carrying tube
wherein said first suction port is oriented to draw ozonated air directly from a region around said ultraviolet lamp and deliver said ozonated air into a flow of water through said first water outlet port and into a first end of said ultraviolet-transparent water carrying tube.

15. The sanitizer system of claim 12, wherein the mixer is a Venturi-type mixer.
